(19) United States
(12) Patent Application Publication
(10) Pub. No.: US 2020/0049132 A1
(43) Pub. Date: Feb. 13, 2020

(54) Offset Weight-Powered Engine

(71) Applicant: Charles Michael Traner, (US)

(72) Inventors: Charles Michael Traner, Arlington, TX (US); Jerry Gene Warthan, Gladewater, TX (US)

(73) Assignee: Jerry Gene Warthan, Gladewater, TX (US)

(21) Appl. No.: 16/537,599

(22) Filed: Aug. 11, 2019

Related U.S. Application Data
(60) Provisional application No. 62/717,905, filed on Aug. 12, 2018.

(51) Int. Cl. F03G 3/00; F03G 7/10

(52) U.S. Cl. CPC F03G 3/00; F03G 7/10

(57) ABSTRACT

An offset weight-powered engine uses gravity to create an unbalanced net moment arm on the engine to overcome the moment of inertia and to produce rotational motion which is converted to energy out of the system. Weights on rotatable arms extend from peripheral points on the main body of the engine, which rotates on a main shaft. The weights are held off-vertical during in a stable, but unbalanced, configuration, to provide leverage and create an over-leveraged situation. This creates a rotational force generating torque and allowing the system to generate power. The rotating weights are maintained in an off-vertical position by a control system. A rotating control assembly holds those weighted arms in position, rotating in unison with the weight arms with a main shaft parallel but offset from the main shaft of the main body, and rotatable arms fixed to the weighted arms and compensating for the offset.

### TECHNICAL FIELD

The present invention relates engines deriving power from torque generated by offset weighting and powered by gravity.

### BACKGROUND OF THE INVENTION

The problem of power generation is age-old. Previously, power was created using fossil fuel-powered engines, and more currently, technology has led to solar and wind powered power generation. It is desirable to eliminate the need for fossil fuels or radioactive elements to generate electricity without harmful emissions or a large carbon footprint. It is also desirable to produce reliable power 24 hours a day, 7 days a week.

An offset weight-powered engine, that is continuously rotating, gravity-powered, generating torque, is similar to a water wheel or windmill, and uses the natural force of gravity as the means to create an unbalanced net moment arm on the engine to overcome the moment of inertia on the apparatus to produce rotational motion which is converted to energy out of the system. Rotating weights are utilized to maximize an over-leveraged situation to create a rotational force that will generate torque. When tied to a power-generating unit, the unit will generate excess power by using gravity as our source of energy. The rotating weights are controlled using motors and possible gear sets to control the rotation or through a control arm assembly rotating in unison with the weight arms having an offset main shaft from the main shaft of the power-generating portion of the device.

### SUMMARY OF THE INVENTION

An embodiment of the invention is generally comprised of a rotating body including rotating radially-oriented lever arms (extending from and supported by a central axle) on a tower structure, the lever arms rotationally-fixed relative to the rotating body's central axis, a generator, and rotating weight arms outwardly on the lever arms. Weight arms may rotate relative to the rest of the rotating body and have a center of weight non-coincident with the point of rotation, so that rotating the weight arm off-vertical creates torque on the rotating body. Additional or fewer lever arms could be used depending upon spacing, weight, and power considerations, or the body could utilize a simplified radially-extending body without distinct arms, supporting the rotating weight arms at lever points fixed thereto. A frame supports the rotating body via the central axle and permits rotation thereabout.

Rotating weight arms are rotated on a sub-axle between the main axle and the terminal (most radially exterior) point on the overall lever arm. The weight arms are rotationally-fixed to the sub-axles. Sub-axles may include a keyway for rotational fixing to other elements, including the weight arms and their supports. The torque position of the rotating weight arms (that is the angle relative to a downward-hanging position) may be controlled by one or more control features, such as direct servo control motor controllers, servo control motors attached to a rotating shaft controlling the position of the rotating weight arms by chains or belts, or by a set of axis-offset control arms rotationally fixed to the rotating body.

Servo motors may be supplied as one motor per weight arm, such as a motor whose output shaft is, or is rotationally joined to the sub-axles, or a single motor driving them in unison, such as by chain drive or gearing. The servo motor or motors are supported on the rotating body.

The rotating body may also include exterior weights, such as along the perimeter of the rotating body near the terminal points of the radial arms. This may be done to increase the overall rotational inertia of the rotating body to damp vibrations or output fluctuations.

The lever arms function by creating an offset weighting effect on the rotating body. Lever arms possess a moment arm acting on the central axle, controlled by their own weight, and the weight supported thereby (such as exterior weights and the rotating weight arms), the weight distribution thereof, and their orientation to gravity.

The torque (driving) effect of the rotating weight arms may be adjusted. The position of all arms is preferably the same and may vary from a small angle (e.g. 10-15 degrees), a moderate angle (30-40) to a large angle (e.g. 50-60, or 70-90 degrees). This angle can be considered a drive angle. The rotating weight arms include a weighting part, which is adjustable either by adjusting the mass of that part or by adjusting the extension of the mass along the rotating weight arm from the sub-axle, or both. Both the position adjustability and the weighting part adjustability permits adjusting the driving effect.

At the start of operation, the rotating weight arms are set by the control feature to a non-zero torque position (such as a horizontal position parallel to the base (or floor). In a horizontal position (or 90-degree torque position), the weight of the rotating weight arm on (for example) the left side of the machine is positioned where the weighting part is rotated to the radial interior of the rotating body (i.e. towards the axle of the overall apparatus) and the weighting part of the rotating weight arm on the opposing (here, right) side of the machine is positioned where the weighting part is rotated to the radial exterior of the arm (i.e. towards the exterior of the overall apparatus). Likewise, the weight arms at the top and bottom of the machine are positioned where the weighting parts are rotated in the same direction (side) as the arms on the left and right sides. The control feature will maintain this horizontal positioning as the overall apparatus rotates, producing a continuous over-leveraged condition causing a rotation of the overall apparatus.

This shift in weight increases the moment arm in one direction on the over-leveraged rotating lever arm (here, to the right) while simultaneously reducing the moment arm in that direction on the opposite rotating lever arm (here, to the left). Likewise, rotating weight arms (at the top and bottom positions) create corresponding moment arm effects. Thereby gravity forces acting on rotating weight arms create a moment on a lever arm, overcoming the moment of inertia for the rotating lever arm, and thereby rotating the rotating body.

This process is repeated each half revolution, as the upper weight arm is rotated to the maximum leveraged position on the high side and the opposite weight arm is rotated to be the minimum leverage position. The process may also be continuous, in which case the rotating weight arms are maintained in a consistent torque position, such the 90-degree position (parallel to the ground). In this case, the rotating weight arm are maintained in a horizontal position (relative to gravity) while the rotating body rotates thereunder. This causes the rotating weight arms to travel in a circular path about the sub-axles relative to the lever arm.

The torque will be used to turn a shaft, and/or via a gearbox which will optimize the rotation to efficiently turn a motor or permanent magnet generator to produce energy. A custom gearbox (or the series of sheaves and pulleys) are attached to the rotating axle in the proper proportion to increase the rotational rpms to the operating rpm requirements of the motor or generator used to generate power. Although servo motors require initial external power, the apparatus generates power in excess of the servo motor requirements once in operation. After startup, the power required by the servomotor can be switched to the output of the devices, as it no longer requires an external power source.

In an embodiment, a passive control feature may be used to maintain weight arms in a leverage position. In this instance, the rotating arms are all positioned to extend to one side of the central axle. For instance, when the main arms are at 0/90/180/270-degrees, one power arm extends away from the central axle (radially outward) on one side of the apparatus, while the opposing side is extended toward the central axle (radially inward). The causes an over-balance, over-leverage situation causing rotation. The rotating arms rotate one rotation per rotation of the main/base rotation. From the frame of reference of the main arms, rotating power arms rotate opposite from the rotation of the main arms rotating around the central axle. From a stable frame of reference, rotating power arms do not rotate but instead maintain their position. The rotating arms are controlled by a control arm system and remain approximately in a horizontal position (or another desired position for providing leverage.

A control system is provided including of a rotating control member mounted on a control shaft via a central control hub. The control shaft is offset from, but parallel to, the main shaft about which the main arms rotate. For instance, the control shaft may be offset by a center-to-center shaft displacement offset of less than the center-to-center radial distance between the main shaft and the axles connecting the power arms to the main arms. That shaft displacement offset may be adjusted to provide desirable leverage and stability characteristics for the control arms. That shaft displacement offset may be vertical (with the control shaft radially displaced above or below the main shaft) or horizontal (with the control shaft radially displaced to one side or the other of the main shaft) or at a non-cardinal direction (with the control shaft radially displaced non-vertically above or below the main shaft and to one side or the other). The control member has a number of control points corresponding to the number of power arms on the main arms. The control points may be at or near the terminal ends of a corresponding number of control arms extending from the central control hub and generally perpendicular to the central control shaft axis.

An axle is mounted at each control point on the control member using bearings to allow rotation. Attached to each axle is a position arm. Position arms rotate freely about that axle relative to the control member and any control arms. But the position arms are rigidly rotationally fixed to the axle on which rotating power arms of the power generating apparatus rotate. Said position arms may, or depending upon the application, must be the same or approximately length as the shaft displacement offset between the control shaft and the main shaft.

The center-to-center radial distance between the control shaft and the axle at the control points may, or depending upon the application, must correspond to the same or approximately the same center-to-center radial distance between the main shaft and the center-to-center radial distance between the main shaft and the axles connecting the power arms to the main arms.

In an embodiment, an upward vertical shaft displacement offset between the control shaft and the main shaft effectively raises the control arm in an offset position to the main power generation apparatus axis. The control points (e.g. at or near distal ends of control arms) support the position arms which may rotate thereon. Position arms extend downward a distance corresponding to the vertical shaft displacement offset and connect to the sub-axle controlling the rotational position of the power arms. In this embodiment, this means the position arms are permanently positioned and locked at a 90-degree angle to the power arms. The position arms extend between the axles of the power arms and the axle of the control arms, and the inter-axle distance and orientation is the same as the main shaft-to-control shaft distance and orientation. This locked relationship between the position control arm and the power arms is used to force the power arms to maintain the desired drive angle, including an approximately horizontal orientation.

Naturally, different power arm drive angles could result in non-right-angle configurations between the power arms and the position arms, even if the shaft displacement offset remained vertical. For instance, a vertical offset and a 70-degree drive angle would result in the position arms positioned and locked at a 110-degree angle to the power arms. Correspondingly, non-vertical shaft displacement offsets would change these values. A horizontal shaft displacement offset in the direction opposite to the lateral extension of the power arms from the sub-axles (at a 90-degree drive angle) would result in a result in the position arms positioned and locked at a 0-degree angle to the power arms.

A starting motor attached to the main axle will start the initial rotation of the device and maintain a specified RPM. Torque is created due to the centrifugal and inertial forces of the overall apparatus. The torque is used to generate power to attached generator systems. The excess power is used to generate more power than the power used to start and maintain the specified RPM's.

This application further expressly incorporates herein the disclosure of U.S. Patent Appl. Ser. No. 62/717,905 and claims the benefit of priority therefrom.

### BRIEF DESCRIPTION OF THE DRAWINGS

FIG. 1 illustrates a front right oblique view of the power generating system, in accordance with an embodiment of the present invention;

FIG. 2 illustrates a front view of the power generating system of FIG. 1;

FIG. 3 illustrates a right-side view of the power generating system of FIG. 1;

FIG. 4 illustrates a left rear oblique view of the power generating system, in accordance with an embodiment of the present invention;

FIG. 5 illustrates a front view of the power generating system of FIG. 4;

FIG. 6 illustrates a right-side view of the power generating system of FIG. 4;

### DETAILED DESCRIPTION

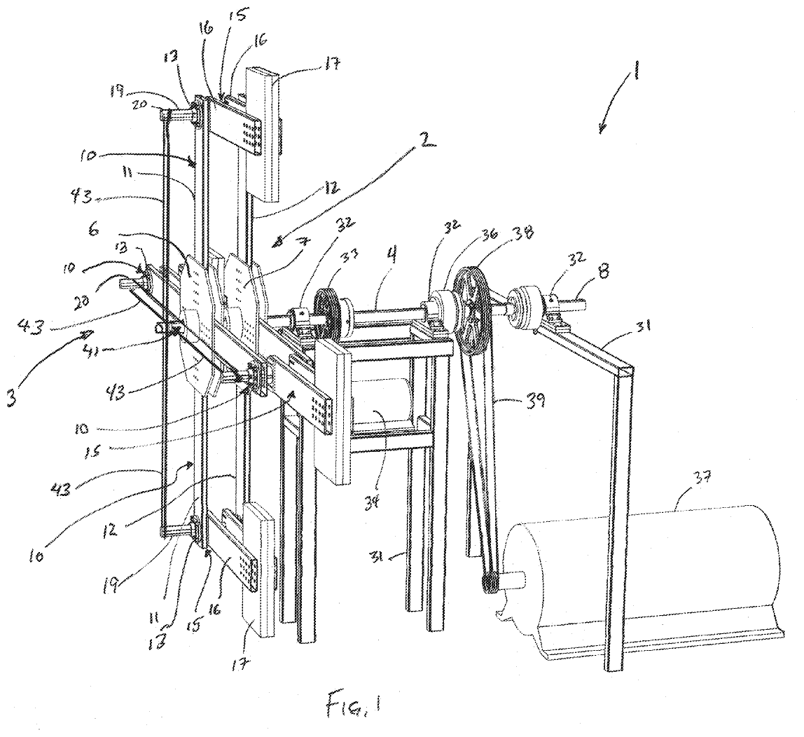

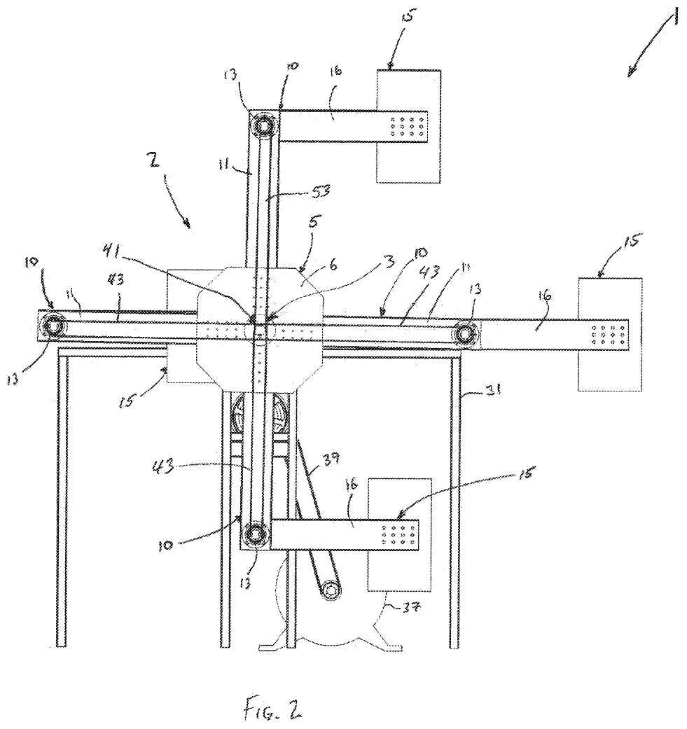

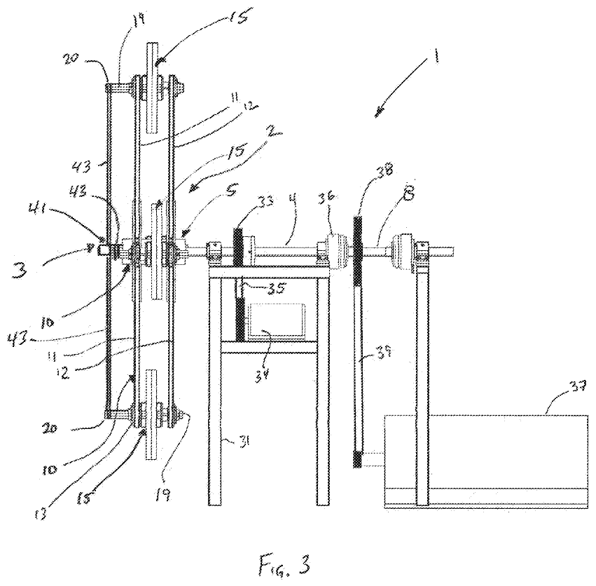

A first embodiment of the power generating system is shown in FIGS. 1-3. System 1 includes main assembly 2 and control gearing assembly 3.

Main assembly 2 includes main shaft 4, hub assembly 5 mounted on main shaft 4, four main arm assemblies 10 mounted on hub assembly 5 at right angles to each other and at right angles to main shaft 4, and four power arm assemblies 15 mounted on main arm assemblies 10. Hub assembly 5, in this embodiment is formed of front & rear bracket sets 6 & 7, each rotationally fixed to main shaft 4 and extending perpendicular to its axis of rotation. Main arm assemblies 10 include front & rear arms 11 & 12. Front & rear arms 11 & 12 are parallel to one another, extending radially outward from main shaft 4, and are mounted at their proximal ends on, respectively front & rear bracket sets 6 & 7. At or near the distal (radially-outward) ends of front & rear arms 11 & 12 are bearing sets 13. Bearing sets 13 are fixed axially parallel to each other, and each support a power arm assembly 15, and permit it to rotate freely relative to its respective main arm assembly 10. Power arm assembly 15 includes support arms 16, which is rotationally fixed via a keyway to, and supported, by sub-axle 19, and weight 17. Sub-axle 19 is mounted in and supported by bearing set 13 on main arm assembly 10. Sub-axle 19 include sprocket 20 at its forward end, which projects forwardly past front arm 11 and beyond bearing set 13.

Control gearing assembly 3 includes sprocketed servo motor assembly 41, and two drive chains 43. Servo motor assembly 41 is mounted on control hub 5 and may be mounted collinear with main shaft 4. Motor rotation of servo motor assembly 41 drives motion of drive chains 43 which, in turn drive sprockets 20 on sub-axles 19. Operation of servo motor assembly 41 may be used to maintain power arm assemblies 15 in a fixed position (i.e. at drive angle) while the portions rotationally fixed to hub assembly 5 rotate. In an alternative embodiment (not shown), servo motor assembly 41 is replaced by one motor per power arm. In an alternative embodiment (not shown), servo motor assembly 51 is mounted off-center on control hub 5, or is fixed in a fixed non-rotating position off main assembly 2.

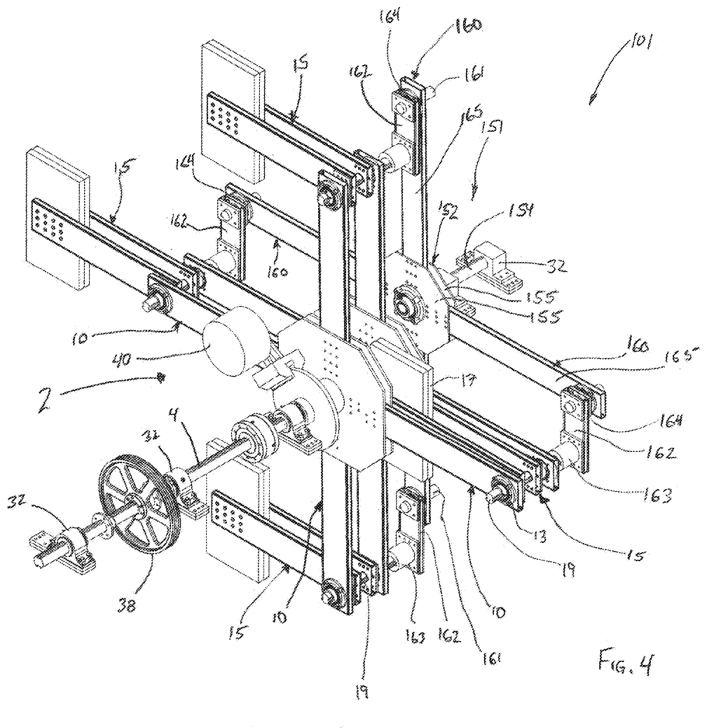

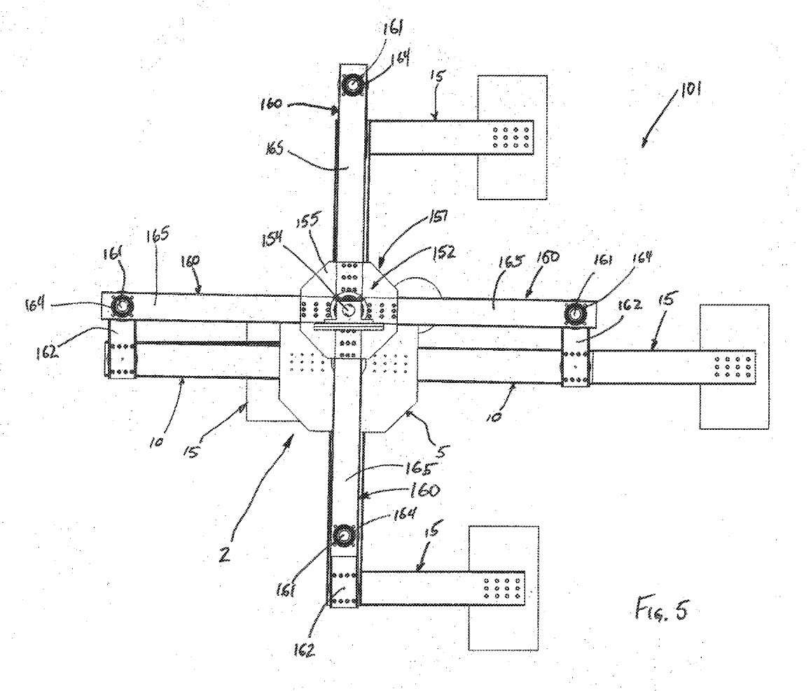

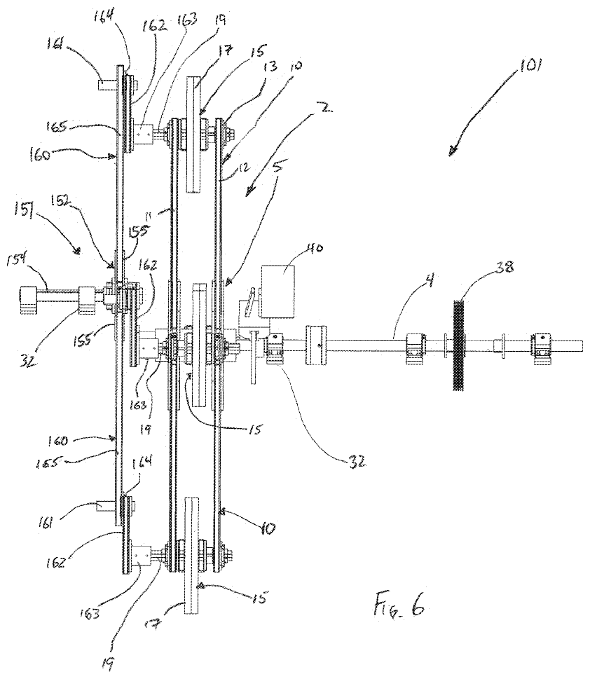

System 1 also includes support frames 31 to support other structures, bearings 32 to support and fix main shaft 4 and power shaft 8 thereon, starter pulley 33 fixed to main shaft 4, starter motor 34 on support frame 31, and starter belt 35 connecting starter pulley 33 and starter motor 34. System 1 also optionally includes brake 40 (shown in FIGS. 4-6), power pulley 38 fixed to main shaft 4, generator 37, and generator belt 39 connecting power pulley 38 and generator 37, and clutch 36 connecting main shaft 4 to power shaft 8. In an alternative embodiment (not shown), pulleys 33 and 38 and belts 35 and 39 are replaced by gearing (or gearboxes) connecting main shaft 4 to starter motor 34 and power shaft 8 to generator 37.

In operation, system 1 is initiated using starter motor 34 to start rotation of the portions of main assembly 2 rotationally fixed to hub assembly 5, and servo motor assembly 41 operates to rotate power arm assemblies 15 to a drive position (off vertical).

As power arm assemblies 15 are driven towards an orientation off vertical, such as parallel to the base or floor, weights 17 at the ends of support arms 16 create an over-leveraged situation, causing main arm assembly 10 to rotate. As servomotor assembly 41 positions power arm assemblies 15 to a drive position, one of power arm assemblies 15 is oriented such that it is weight is extended towards the radial outward end of main arm assembly 10. The opposing power arm assembly 15 at the same time is positioned toward main shaft 4, the weights of the respective power arm assemblies 15 thereby causing the overleveraged situation via the applied torque on main arm assemblies 10.

As main assembly 2 rotates in a clockwise fashion, weights 17 rotate in a counterclockwise fashion (relative to hub assembly 5 and main arm assemblies 10), always maintaining the drive orientation (e.g. parallel to the base or floor), continuously generating the over-leveraged situation. This shift in weight lengthens the moment arm on the over-leveraged segment of the rotating lever arm while simultaneously shortening the moment arm on the opposite segment of the rotating lever arm, thereby allowing gravity to rotate the lever arm by overcoming the moment of inertia for the rotating lever arm. Continuing applied torque to main arm assemblies 10 is transmitted to hub assembly 5 and thence to main shaft 4. Main shaft 4 rotates, passing the power through clutch 36 (when engaged) to power pulley 38, and via generator belt 39 to generator 37 to generate electric power. The system could be designed to reverse the direction of rotation by reversing the component orientation for driving a device needing a different input, or a reversing gearbox could be provided.

A second embodiment of the power generating system is shown in FIGS. 4-6. System 101 includes main assembly 2 and control assembly 151. Structures common to the FIGS. 1-3 retain the same numbering, and some have been omitted from FIGS. 4-6 in the interests of clarity.

Main assembly 2 includes main shaft 4, hub assembly 5 mounted on main shaft 4, four main arm assemblies 10 mounted on hub assembly 5 at right angles to each other and at right angles to main shaft 4, and four power arm assemblies 15 mounted on main arm assemblies 10. Hub assembly 5, in this embodiment is formed of front & rear bracket sets 6 & 7, each rotationally fixed to main shaft 4 and extending perpendicular to its axis of rotation. Main arm assemblies 10 include front & rear arms 11 & 12. Front & rear arms 11 & 12 are parallel to one another, extending radially outward from main shaft 4, and are mounted at their proximal ends on, respectively front & rear bracket sets 6 & 7. At or near the distal (radially-outward) ends of front & rear arms 11 & 12 are bearing sets 13. Bearing sets 13 are fixed axially parallel to each other, and each support a power arm assembly 15, and permit it to rotate freely relative to its respective main arm assembly 10. Power arm assembly 15 includes support arms 16, which is rotationally fixed via a keyway to, and supported, by sub-axle 19, and weight 17. Sub-axle 19 is mounted in and supported by bearing set 13 on main arm assembly 10. Sub-axle 19 projects forwardly past front arm 11 and beyond bearing set 13.

Control assembly 151 includes control shaft 154, associated bearings 32, control hub assembly 152 mounted on control shaft 154, and four control arm assemblies 160 mounted on control hub assembly 152 at right angles to each other and at right angles to control shaft 154. Control hub assembly includes brackets 155 supporting control arm assemblies 160 at their proximal (radially-inward) end. Control arm assembly 160 includes control arm 165, bearing set 164 at or near the distal end of control arm 165, position arm 162, sub-axle 161, and pinplate 163. Sub-axle 161 is mounted in bearing set 164 and supports position arm 162 at or near one end thereof from control arm 165 and allows position arm 162 rotation relative thereto. Pinplate 163 is rotationally fixed to position arm 162 at or near the opposite one end thereof from sub-axle 161, and rotationally fixes and supports keyed sub-axle 19.

Control shaft 154 is offset vertically upward from main shaft 4, but is parallel thereto, forming a center-to-center shaft offset distance. A corresponding shaft-to-shaft offset relationship exists between sub-axles 161 (on control arm assemblies 160) supporting position arms 162, and sub-axles 19 (on main arm assemblies 10) supporting power arm assemblies 15. The vertical shaft displacement offset effectively raises control assembly 151, and control arm assemblies 160, and places them in the same offset relationship to main arm assemblies 10. In this embodiment, position arms 162 hang down from, and are permitted to rotate relative to, control arms 165, but pinplate 163 locks sub-axle 19 rotationally thereto. Thus, controlling the rotational position of position arms 162 controls the rotational position of power arm assemblies 15, which are similarly fixed to sub-axle 19. In this embodiment, position arms 162 are vertical and pinplate 163 locks power arm assemblies 15 into a 90-degree relationship, holding them horizontally to the ground.

System 101 also includes support frames (not shown, see FIGS. 1-3), bearings 32 to support and fix main shaft 4 thereon, starter pulley, starter motor, and starter belt (all not shown, see FIGS. 1-3). System 101 also optionally includes brake 40, power pulley 38 fixed to main shaft 4, and generator, generator belt, and clutch (all not shown, see FIGS. 1-3).

In operation, system 101 may be initiated using a starter motor as described above to start rotation of the portions of main assembly 2 rotationally fixed to hub assembly 5. The shaft offset forces position arms 162 to maintain a vertical position, thus holding power arm assemblies 15 to a drive position (off vertical). As a consequence, bearing sets 164, position arms 162, pinplates 163, and control arms 165 will experience changing forces as control assembly 151 and main assembly 2 rotate together. Depending upon the relative position of power assemblies 15, they will create torque resulting in alternating compressive forces and tension forces on those elements.

As above, power arm assemblies 15 are in an orientation off vertical, such as parallel to the base or floor, and weights 17 at the ends of support arms 16 create an over-leveraged situation, causing main arm assembly 10 to rotate. One of power arm assemblies 15 is oriented such that its weight is extended towards the radial outward end of main arm assembly 10. The opposing power arm assembly 15 at the same time is positioned toward main shaft 4. The weights of the respective power arm assemblies 15 thereby cause the overleveraged situation via the applied torque on main arm assemblies 10.

As main assembly 2 rotates in a clockwise fashion, weights 17 rotate in a counterclockwise fashion (relative to hub assembly 5 and main arm assemblies 10), always maintaining the drive orientation (e.g. parallel to the base or floor), continuously generating the over-leveraged situation. This shift in weight lengthens the moment arm on the over-leveraged segment of the rotating lever arm while simultaneously shortening the moment arm on the opposite segment of the rotating lever arm, thereby allowing gravity to rotate the lever arm by overcoming the moment of inertia for the rotating lever arm. Continuing applied torque to main arm assemblies 10 is transmitted to hub assembly 5 and thence to main shaft 4. Main shaft 4 rotates, passing the power to power pulley 38, and thence to a generator (not shown) to generate electric power.

1. A rotating offset weight-powered engine for generating power, comprising:
a power-generating assembly, comprising
a main shaft about which said power-generating assembly may rotate;
a plurality of weighted arms rotatably mounted on said power-generating assembly at a lever distance from a centerline of said main shaft; and
a control system maintaining said weighted arms in an offset weight configuration during rotation of said power-generating assembly, said control system comprising
a secondary shaft about which the control system may rotate;
a plurality of control arms rotatably mounted on said control system at the lever distance from a centerline of said secondary shaft;
each of said plurality of control arms connected to a corresponding one of said plurality of weighted arms in a fixed rotational relationship.

2. The engine of claim 1:
said secondary shaft centerline and said main shaft centerline parallel to one another but separated by an offset distance;
each of said plurality of weighted arms rotatably mounted at a first rotational sub-axis;
each of said plurality of control arms rotatably mounted at a second rotational sub-axis; and
the second rotational sub-axis for one of said control arms separated by the offset distance from the first rotational sub-axis for the weighted arm connected to said one of said control arms.

3. The engine of claim 2:
said secondary shaft centerline offset from said main shaft centerline in an offset direction; and
the second rotational sub-axis for one of said control arms separated in the offset direction from the first rotational sub-axis for the weighted arm connected to said one of said control arms.

4. The engine of claim 1:
each of said plurality of weighted arms comprising a center of weight; and
each of said plurality of weighted arms rotatably mounted on said power-generating assembly at a mounting point on said weighted arms;
said mounting points at a distance from said center of weight.

5. The engine of claim 4:
said offset weight configuration comprising a line formed between the mounting point and the center of weight on each of said plurality of weighted arms forming a non-zero angle to a local gravitational down direction.

6. The engine of claim 5:
said angles being substantially the same for each of said weighted arms.

7. The engine of claim 1:
said offset weight configuration comprising said plurality of weighted arms each being off-vertical in a range of about 10-degrees to about 90-degrees;
each of said weighted arms being off-vertical by approximately the same amount.

8. The engine of claim 1:
said power-generating assembly further comprising a plurality of main arms extending radially outward from the main shaft toward a distal end; and
each of said plurality of weighted arms rotatably mounted on one of said plurality of main arms at a position between the main shaft and said distal end.

9. The engine of claim 1 further comprising:
a generator coupled to the main shaft.

10. A method of generating power from a rotating offset weight-powered engine, comprising:
rotating a power-generating assembly about a main shaft thereof, said rotating step comprising
rotatably mounting a plurality of weighted arms on said power-generating assembly at a lever distance from a centerline of said main shaft; and
applying torque to the power-generating assembly by maintaining said plurality of weighted arms in an offset weight configuration during the rotation step; and
said maintaining step comprising
rotating a control system about a secondary shaft;
rotatably supporting a plurality of control arms on said control system at the lever distance from a centerline of said secondary shaft; and
holding each of said plurality of weighted arms in a fixed rotational relationship to a corresponding one of each of said plurality of control arms.

11. The method of claim 10:
said secondary shaft and said main shaft centerline centerline parallel to one another but separated by an offset distance;
said rotatably mounting step at a first rotational sub-axis; and
said rotatably supporting step at a second rotational sub-axis; and
the second rotational sub-axis for one of said control arms separated by the offset distance from the first rotational sub-axis for the weighted arm connected to said one of said control arms.

12. The method of claim 10:
each of said plurality of weighted arms comprising a center of weight; and
said rotatably mounting step comprising mounting each of said plurality of weighted arms on said power-generating assembly at a mounting point on said weighted arms;
said mounting points at a distance from said center of weight.

13. The method of claim 10:
said maintaining step further comprising holding each of said plurality of weighted arms each off-vertical approximately the same amount and in a range of about 10-degrees to about 90-degrees.

14. The method of claim 10:
said rotating a power-generating assembly and rotating a control system steps further comprising said rotating taking place in unison.

15. The method of claim 10:
said rotatably supporting step comprising supporting each of said plurality of control arms at a proximal end thereof;
said holding step comprising
fixing a distal end each of said plurality of control arms to one each of said plurality of weighted arms; and
applying a force to a proximal end of said control arms.

16. The method of claim 15:
said main shaft centerline and said secondary shaft centerline parallel to one another and said secondary shaft centerline being vertically above said main shaft centerline;
said rotatably supporting step further comprising supporting each of said plurality of control arms in a vertical configuration.
holding each of said plurality of weighted arms in a fixed rotational relationship to a corresponding one of each of said plurality of control arms.

17. A rotating offset weight-powered engine for generating rotational torque, comprising:
a rotating generating assembly for undergoing rotation, comprising a main shaft;
a main body mounted on the main shaft, said main body comprising
at least two leverage points radially outward of the main shaft; and
at least two power arms;
each of said at least two power arms supported by a corresponding one of said at least two leverage points and rotatable with respect thereto;
and each of said at least two power arms capable of assuming a static non-vertical configuration during rotation of rotating generating assembly; and
a control system configured to maintain said at least two power arms in said non-vertical configuration during rotation of rotating generating assembly.

18. The engine of claim 17:
each of said at least two power arms creating torque on said main shaft in said non-vertical configuration.

19. The engine of claim 17:
each said at least two power arms rotatable with respect to its corresponding leverage point about a power arm axis; and
each said at least two power arms comprising a center of weight;
wherein said center of weight and said power arm axis are non-coincident.

20. The engine of claim 19:
said non-vertical configuration comprising a leverage angle formed between a local gravitational down direction and a line formed between said center of weight and said power arm axis;
said leverage angle in a range between 10-degrees and 90-degrees.

21. The engine of claim 17:
said main body comprising at least two main arms extending radially outward from the main shaft toward a distal end;
each of said at least two leverage points located on one of said at least two main arms at a position between the main shaft and said distal end.

22. The engine of claim 17:
said main shaft aligned to a main axis;
said control system comprising
a control shaft aligned to a control shaft axis;
a control body mounted on the control shaft, said control body comprising
at least two control points radially outward of the control shaft; and
at least two positioning arms;
each of said at least two positioning arms supported by a corresponding one of said at least two control points and rotatable with respect thereto;
each of said at least two positioning arms rotationally fixed to a corresponding one of said at least two power arms;
said main axis and said control shaft axis parallel to one another but offset by a shaft offset distance.

23. The engine of claim 22:
each said at least two power arms rotatable with respect to its corresponding leverage point about a power arm axis; and
each of said at least two positioning arms rotatable with respect its corresponding control points about a positioning arm axis;
said main axis and said control shaft axis parallel to one another but offset by said shaft offset distance; and
said positioning arm axis and said power arm axis parallel to one another but offset by said shaft offset distance.
